(19) United States
(12) Patent Application Publication
(10) Pub. No.: US 2013/0016671 A1
(43) Pub. Date: Jan. 17, 2013

(54) Method of Handling Coordinated Scheduling for Base Stations and Mobile Devices and Related Communication Device

(71) Applicants: Hao-Chung Cheng, Taipei City (TW); Jhe-Syong Jiang, Taipei City (TW); Ling-San Meng, Taipei City (TW); Ping-Cheng Yeh, Taipei City (TW); Yu-Chih Jen, Taoyuan County (TW)

(72) Inventors: Hao-Chung Cheng, Taipei City (TW); Jhe-Syong Jiang, Taipei City (TW); Ling-San Meng, Taipei City (TW); Ping-Cheng Yeh, Taipei City (TW); Yu-Chih Jen, Taoyuan County (TW)

(21) Appl. No.: 13/351,247

(22) Filed: Jan. 17, 2012

Related U.S. Application Data
(60) Provisional application No. 61/433,276, filed on Jan. 17, 2011.

(51) Int. Cl. H04W 72/04

(52) U.S. Cl. 370/329

(57) ABSTRACT

A method of associating a plurality of mobile devices with a plurality of transmission points in a wireless communication system for a set of the plurality of transmission points is disclosed. The method comprises dividing the plurality of mobile devices into a plurality of mobile device groups according to a plurality of signal qualities between the plurality of transmission points and the plurality of mobile devices by using at least one statistical learning technique; and associating one of the plurality of mobile device groups with one of a plurality of transmission groups, wherein the plurality of transmission groups are obtained from the plurality of transmission points.

### CROSS REFERENCE TO RELATED APPLICATIONS

This application claims the benefit of U.S. Provisional Application No. 61/433,276, filed on Jan. 17, 2011 and entitled “Methods and Apparatus for Coordinated Scheduling for Base Stations and Mobile Users in Cellular Environments”, the contents of which are incorporated herein in their entirety.

### BACKGROUND OF THE INVENTION

1. Field of the Invention

The present invention relates to a method used in a wireless communication system and related communication device, and more particularly, to a method of handling coordinated scheduling for base stations and mobile devices and related communication device.

2. Description of the Prior Art

A long-term evolution (LTE) system supporting the 3GPP Rel-8 standard and/or the 3GPP Rel-9 standard are developed by the 3rd Generation Partnership Project (3GPP) as a successor of a universal mobile telecommunications system (UMTS), for further enhancing performance of the UMTS to satisfy increasing needs of users. The LTE system includes a new radio interface and a new radio network architecture that provides a high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple UEs, and communicates with a core network including a mobility management entity (MME), a serving gateway, etc., for Non Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint transmission/reception (CoMP), UL multiple-input multiple-output (MIMO), etc. For a UE and an eNB to communicate with each other in the LTE-A system, the UE and the eNB must support standards developed for the LTE-A system, such as the 3GPP Rel-10 standard or later versions.

When the CoMP is configured to a UE and multiple transmission points (e.g. a base station, a relay node or a remote antenna of a base station), the UE may communicate with the transmission points simultaneously, i.e., access a service via all or part of the transmission points. More specifically, an eNB may manage only one transmission point, or may manage multiple transmission points (e.g. via remote radio head (RRH)). That is, Cell IDs of different transmission points may be different (e.g. when being managed by different eNBs), or may be the same (e.g. when being managed by the same eNB). Thus, signals transmitted between the UE and the transmission points can be easily recovered due to better quality of the signals. In detail, when the transmission points are involved in the CoMP, one of the transmission points is a serving point (e.g. serving cell). In general, link quality between the serving point and the UE is better than those between other transmission points and the UE. Control information required for the CoMP is usually transmitted by the UE to the serving point first. Then, the serving point exchanges the control information with other transmission points such that the CoMP can operate regularly. Further, the CoMP can be classified into two main categories: Joint Processing (JP) and Coordinated Scheduling/Beamforming (CS/CB). A main difference between the JP and the CS/CB is that data of the UE is available at all the transmission points when the JP is configured (i.e. enabled), while the data of the UE is only available at the serving point when the CS/CB is configured. The JP can be further divided into two categories: joint transmission and dynamic cell selection. When the joint transmission is configured, the data of the UE can be transmitted from multiple transmission points (e.g. coherently or noncoherently) to the UE to improve signal quality and/or cancel interferences. When the dynamic cell selection is configured, the data of the UE is transmitted from only one of the transmission points (e.g. according to a choice or suggestion of the UE) to the UE to improve signal quality and/or avoid the interferences. On other hand, when the CS/CB is configured, the data of the US is only transmitted from the serving point to the UE, while other transmission points may stop transmissions or adjust beamforming to mitigate the interferences.

Furthermore, when the CoMP is configured to multiple UEs, the transmission points may need to perform transmissions and receptions with the UEs simultaneously. If all the transmission points perform the transmissions and the receptions with all the UEs without considering efficiency of the CoMP, resources (e.g. wireless resources and/or backhaul resources) are utilized inefficiently and benefit of the CoMP is reduced. For example, channel conditions of the UEs are usually different due to various locations and movements of the UEs. Thus, it is not efficient to jointly processing the transmissions and the receptions of all the UEs. On the other hand, a transmission point may not improve throughputs of the UEs efficiently due to long distances or low signal qualities between the transmission point and the UEs. If the transmission point joins the CoMP, not only the resources are required for exchanging coordination information such as information of the UEs, signal qualities between transmission points and the UEs, etc., but additional latency is caused when exchanging the coordination information. Therefore, how to associate transmission points and UEs for performing the transmissions and the receptions such that the throughputs of the UEs are maximized efficiently is a topic to be discussed and addressed.

### SUMMARY OF THE INVENTION

The present invention therefore provides a method and related communication device for associating a plurality of UEs and a plurality of transmission points to solve the abovementioned problems.

A method of associating a plurality of mobile devices with a plurality of transmission points in a wireless communication system for a set of the plurality of transmission points is disclosed. The method comprises dividing the plurality of mobile devices into a plurality of mobile device groups according to a plurality of signal qualities between the plurality of transmission points and the plurality of mobile devices by using at least one statistical learning technique; and associating one of the plurality of mobile device groups with one of a plurality of transmission groups, wherein the plurality of transmission groups are obtained from the plurality of transmission points.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a schematic diagram of a wireless communication system according to an example of the present invention.

FIG. 5 is a flowchart of a process according to an example of the present invention.

### DETAILED DESCRIPTION

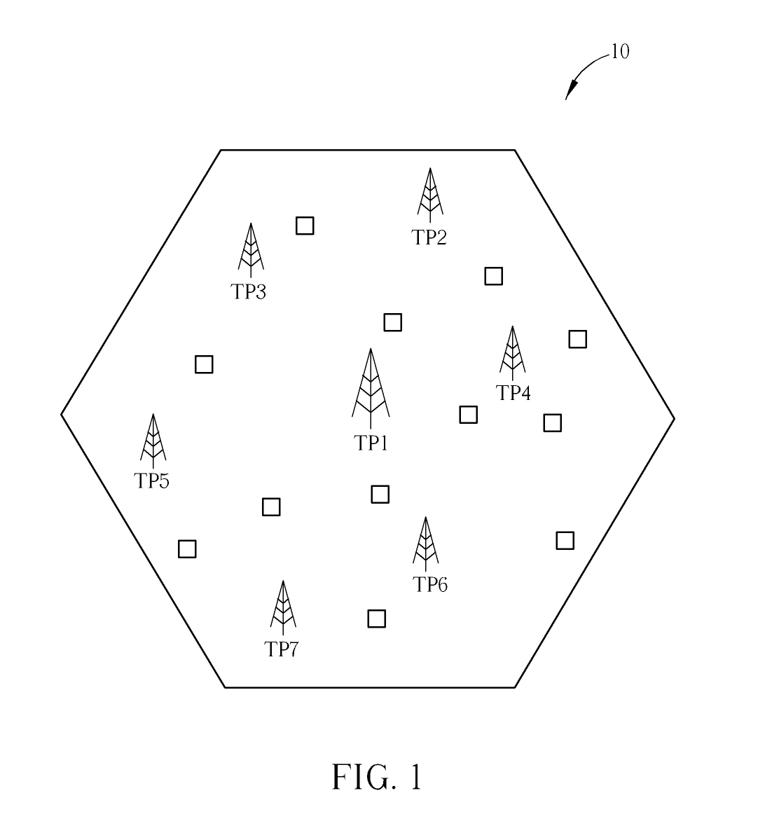

Please refer to FIG. 1, which is a schematic diagram of a wireless communication system 10 according to an example of the present invention. The wireless communication system 10 is briefly composed of 7 transmission points TP1-TP7 (i.e., 7 cells) and UEs represented by blank squares. The wireless communication system 10 may be a wideband code division multiple access (WCDMA) system such as a universal mobile telecommunications system (UMTS). Alternatively, the wireless communication system 10 may be an orthogonal frequency-division multiplexing (OFDM) system and/or an orthogonal frequency-division multiple access (OFDMA) system, such as a long term evolution (LTE) system or a LTE-Advanced (LTE-A) system.

In detail, the transmission points TP1-TP7 perform coordinated multipoint transmission/reception (CoMP) (i.e., multi-cell transmissions and receptions) with the UEs. That is, the transmission points TP1-TP7 can jointly perform multi-cell transmissions and receptions with a UE to improve throughput of the UE. Further, some or all of the transmission points TP1-TP7 can be serving points (i.e., serving cells) for neighboring UEs according to signal quality between the transmission points TP1-TP7 and the UEs.

Please note that, the UEs and the transmission points TP1-TP7 are simply utilized for illustrating the structure of the wireless communication system 10. Practically, the transmission points TP1-TP7 can be referred to as a Node-B (NB) (i.e., macrocell base station (BS)) in a universal terrestrial radio access network (UTRAN) of the UMTS or an evolved NB (eNB) in an evolved UTRAN (E-UTRAN) of the LTE system or the LTE-A system, and is not limited herein. Alternatively, the transmission points TP1-TP7 can be the NBs or the eNBs with small coverage or newly developed BSs with all or part of functions of the NBs or the eNBs, e.g., relay nodes, femtocell BSs, picocell BSs, or remote antennas of the macrocell BS. Besides, the transmission points TP1-TP7 can be remote radio heads (RRHs) in the LTE-A system. The UEs can be mobile devices such as mobile phones, laptops, tablet computers, electronic books, and portable computer systems. Besides, a transmission point and a UE can be seen as a transmitter or a receiver according to transmission direction, e.g., for an uplink (UL), the UE is the transmitter and the transmission point is the receiver, and for a downlink (DL), the BS is the transmitter and the UE is the receiver.

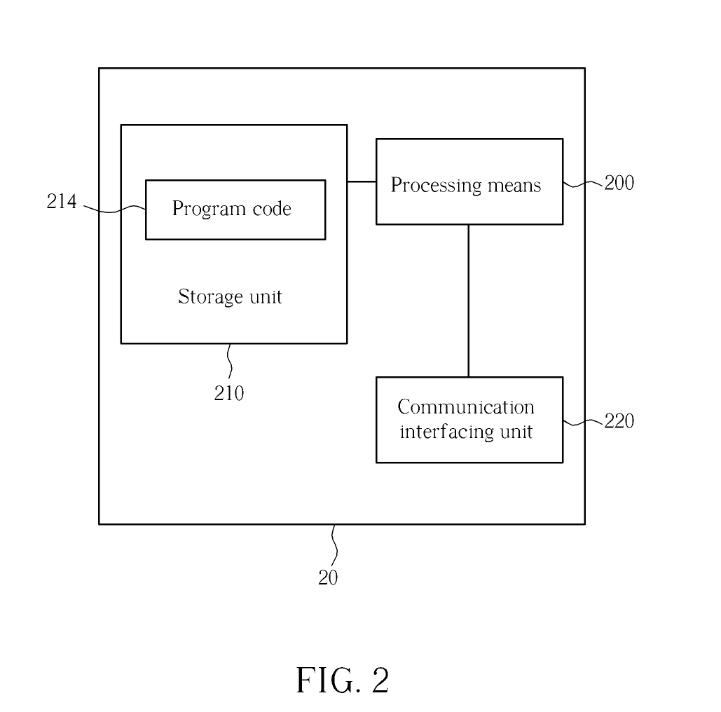

Please refer to FIG. 2, which is a schematic diagram of a communication device 20 according to an example of the present invention. The communication device 20 can be a UE or a transmission point shown in FIG. 1, but is not limited herein. The communication device 20 may include a processing means 200 such as a microprocessor or an Application Specific Integrated Circuit (ASIC), a storage unit 210 and a communication interfacing unit 220. The storage unit 210 may be any data storage device that can store a program code 214, accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a radio transceiver and can exchange wireless signals with the network according to processing results of the processing means 200.

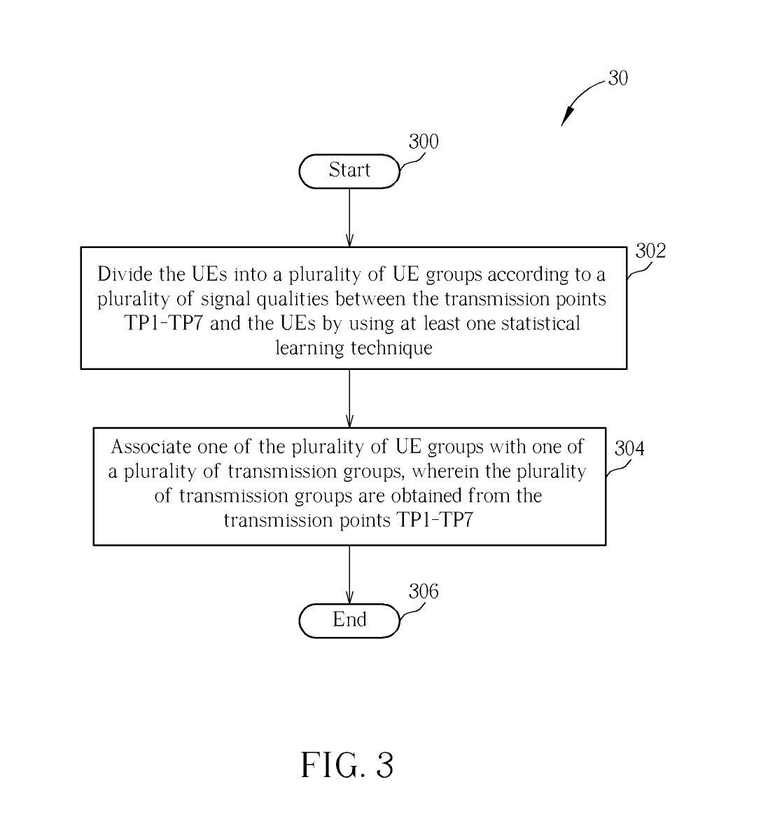

Please refer to FIG. 3, which is a flowchart of a process 30 according to an example of the present invention. The process 30 is utilized in a set of the transmission points TP1-TP7 shown in FIG. 1, for associating the UEs and the transmission points TP1-TP7. For example, the set of the transmission points TP1-TP7 can be a central node (e.g. the transmission points TP1) which realizes the process 30 by itself. Alternatively, the set of the transmission points TP1-TP7 can be serving points (i.e., serving cells) in the transmission points TP1-TP7 which cooperate (e.g. exchanging coordination information) to realize the process 30. Furthermore, the process 30 can also be realized by a switching center such as a mobility management entity (MME) or a radio network controller (RNC), and is not limited herein. The process 30 may be compiled into the program code 214 and includes the following steps:

Step 300: Start.

Step 302: Divide the UEs into a plurality of UE groups according to a plurality of signal qualities between the transmission points TP1-TP7 and the UEs by using at least one statistical learning technique.

Step 304: Associate one of the plurality of UE groups with one of a plurality of transmission groups, wherein the plurality of transmission groups are obtained from the transmission points TP1-TP7.

Step 306: End.

In the following, the transmission points TP1 is served the central node, for illustrating the process 30. According to the process 30, the transmission point TP1 divides the UEs into the plurality of UE groups according to the plurality of signal qualities between the transmission points TP1-TP7 and the UEs by using the at least one statistical learning technique. Then, the transmission point TP1 associates the one of the plurality of UE groups with the one of the plurality of transmission groups, wherein the plurality of transmission groups are obtained from the transmission points TP1-TP7. In other words, since the transmission point TP1 has signal qualities between each UE and each transmission point, the transmission point TP1 can divide the UEs into multiple UE groups by using one or more statistical learning techniques, wherein each UE group is associated a corresponding transmission group including one or more transmission points. Then, multi-cell transmissions and receptions are only performed between a UE group and its corresponding transmission group. Therefore, not only throughput of the UE group (i.e., throughputs of the UEs of the UE group) is maximized, but resources (e.g. wireless resources and/or backhaul resources) and latency required for exchanging coordination information between the transmission points is reduced. As a result, benefit of the CoMP (i.e., multi-cell transmissions and receptions) is realized efficiently.

Please note that, a spirit of the process 30 is that UEs are divided into UE groups by using one or more statistical learning techniques, and each UE group only performs multi-cell transmissions and receptions with a corresponding transmission group including one or more transmission points, such that resources and latency required for exchanging coordination information between the transmission points is reduced. Realizations, extensions and modifications of the process 30 are not limited. For example, the UE groups are preferably disjoint. That is, a UE belonging to one UE group will not belong to another UE group. Besides, except dividing the transmission points TP1-TP7 into transmission groups arbitrarily (e.g. according to geographic locations of the transmission points TP1-TP7), the transmission points TP1 can also divide the transmission points TP1-TP7 into the transmission groups according to signal qualities between the transmission points TP1-TP7 and the UEs by using at least one statistical learning technique. Thus, throughputs of the UEs can be further improved.

On the other hand, the signal qualities can be any information related to strength and/or quality of signals received by the UEs such as signal-to-noise-plus-interference ratios (SINRs). Besides, the signal qualities between the transmission points TP1-TP7 and the UEs can be determined according to channel qualities of channels between the transmission points TP1-TP7 and the UEs. That is, signal quality between a UE and a transmission point is determined according to channel quality of a channel between the UE and the transmission point. Preferably, the channel qualities is measured by the UEs and is fed back to the transmission points TP1 for determining the signal qualities. Further, each of the UEs can feed back the channel qualities by using any control signaling such as a channel gain vector or a channel quality indicator (CQI), and is not limited. If a number of the transmitting points is large, i.e. an amount of the channel qualities is also large, the UEs can feed back only part of the channel qualities, to reduce overhead caused by feeding back the channel qualities. For example, after a UE measures channel qualities of channels between the transmission points TP1-TP7 and the UE, the UE may only feed back the channel qualities of the channels between the transmission points TP1-TP3 and the UE since these channel qualities are above a predetermined level and the others are below the predetermined level.

On the other hand, the transmitting point TP1 can remove a UE from a UE group, if the UE is determined unsuitable for the UE group according to a criterion. For example, the transmitting point TP1 can determine the UE unsuitable, if orthogonality between the UE and the UE group is below a predetermined level. That is, throughput of the UE cannot be improved efficiently if the UE is in the UE group. Alternatively, the transmitting point TP1 can determine the UE unsuitable, if the throughput of the UE is larger than a target level. The target level can be average throughput of the UE group, or a predetermined throughput, and is not limited. That is, the throughput of the UE is large enough, and the UE does not need multi-cell transmissions and receptions. After the UE is removed from the UE group, the UE can be moved to another UE group according to the process 30 and the above examples, and is not limited herein.

Please note that, the process 30 and the above examples are realized based on that the transmitting point TP1 is served as a central node for executing steps such as dividing the UEs into the UE groups, dividing the transmission points TP1-TP7 into the transmission groups, associating the UE groups and the transmission groups, receiving the signal qualities, etc. However, the process 30 and the above examples can also be jointly realized by part or all of the transmission points TP1-TP7. That is, a UE only feedbacks coordination information (e.g. signal qualities) to one of these transmission points, and these transmission points can share the coordination information via backhauls. Then, these transmission points can execute abovementioned steps accordingly. Preferably, these transmission points are serving points (i.e., serving cells). Furthermore, the process 30 can also be realized by a switching center such as a MME or a RNC, which usually has the coordination information for realizing the process 30, and is not limited herein. Besides, a statistical learning technique can be any machine learning method such as K-Means Clustering, Gaussian Mixtures or a combination of the K-Means Clustering and the Gaussian Mixtures, and is not limited.

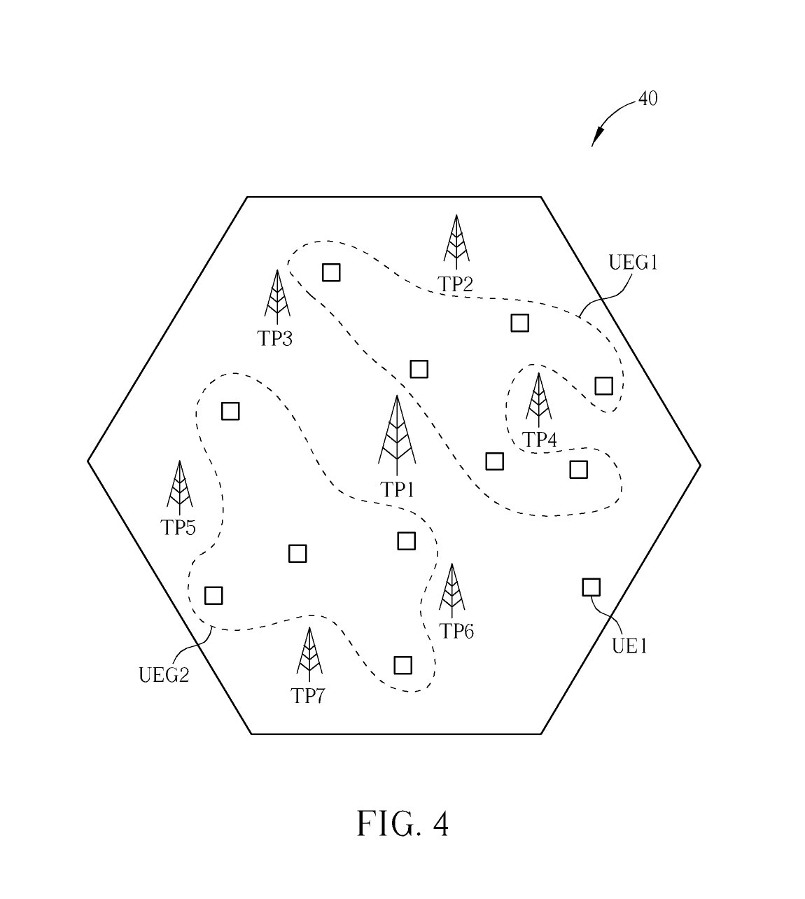

For example, please refer to FIG. 4, which is a schematic diagram of a wireless communication system 40 according to an example of the present invention. The wireless communication system 40 can be seen as a result, after the process 30 and the above examples are applied to the wireless communication system 10. In FIG. 4, the transmission point TP1 divides UEs into 2 UE groups UEG1-UEG2 except a UE UE1 according to the process 30 and the above examples. The UE UE1 is removed from one of the UE groups UEG1-UEG2 (e.g. the UE group UEG1) after the transmission point TP1 determines the UE UE1 unsuitable for the UE group UEG1. The UE UE1 may be moved to the UE group UEG2 later, e.g. after the transmission point TP1 divides the UEs again. Furthermore, the transmission points TP1-TP7 are divided into 2 transmission groups TG1-TG2, wherein the transmission group TG1 includes the transmission points TP1-TP4 and the transmission group TG2 includes the transmission points TP1, TP3 and TP5-TP7. That is, the transmission points TP1 and TP3 belong to both the transmission groups TG1-TG2 (e.g. due to better signal quality or geographic location). Then, the transmission group TG1 only performs multi-cell transmissions and receptions with the UE group UEG1, and the transmission group TG2 only performs the multi-cell transmissions and receptions with the UE group UEG2. Therefore, not only throughput of the UE groups UEG1-UEG2 (i.e., throughputs of the UEs of the UE groups UEG1-UEG2) is maximized, but resources and latency required for exchanging coordination information between the transmission points TP1-TP7 is reduced. As a result, benefit of the multi-cell transmissions and receptions is realized efficiently.

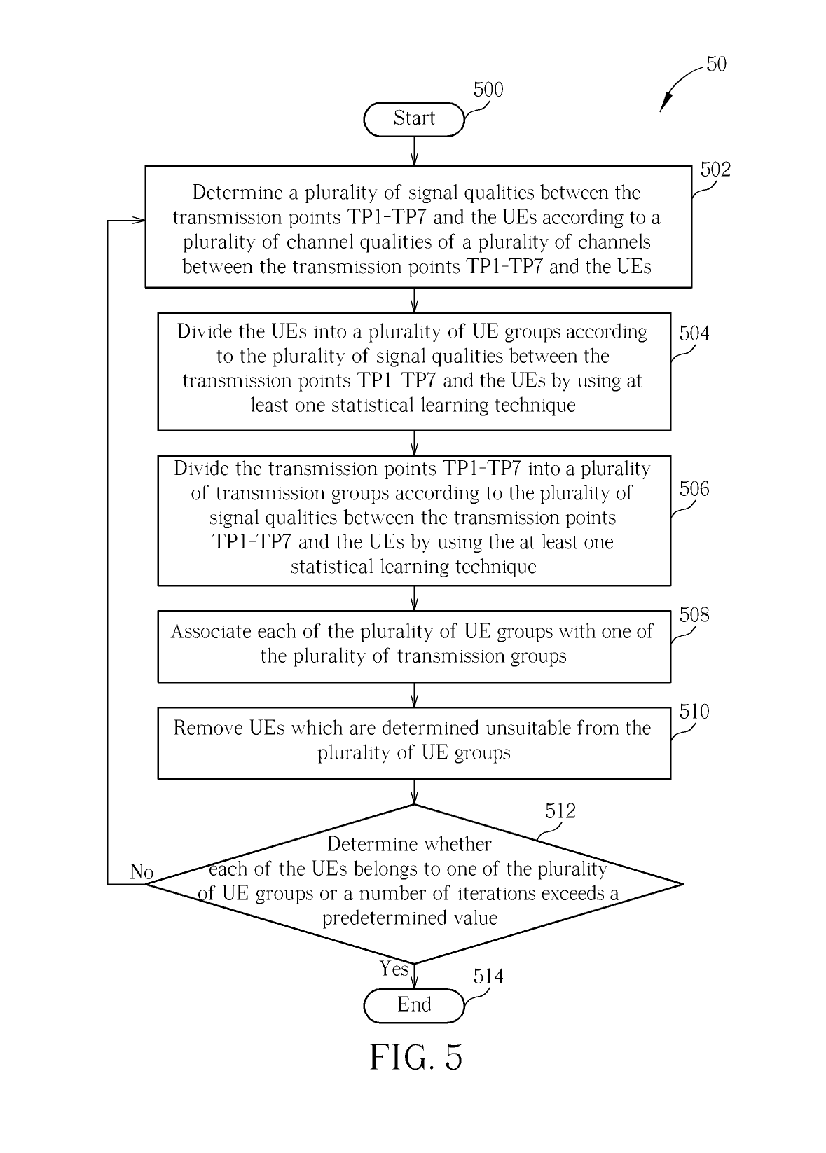

The process 30 and the above examples can be further combined into a process 50 as shown in FIG. 5. The process 50 can be executed iteratively by the transmission point TP1 (e.g. the central node), or by all or part of the transmission points TP1-TP7. The process 50 may be compiled into the program code 214 and includes the following steps:

Step 500: Start.

Step 502: Determine a plurality of signal qualities between the transmission points TP1-TP7 and the UEs according to a plurality of channel qualities of a plurality of channels between the transmission points TP1-TP7 and the UEs.

Step 504: Divide the UEs into a plurality of UE groups according to the plurality of signal qualities between the transmission points TP1-TP7 and the UEs by using at least one statistical learning technique.

Step 506: Divide the transmission points TP1-TP7 into a plurality of transmission groups according to the plurality of signal qualities between the transmission points TP1-TP7 and the UEs by using the at least one statistical learning technique.

Step 508: Associate each of the plurality of UE groups with one of the plurality of transmission groups.

Step 510: Remove UEs which are determined unsuitable from the plurality of UE groups.

Step 512: Determine whether each of the UEs belongs to one of the plurality of UE groups or a number of iterations exceeds a predetermined value. If yes, perform step 514; otherwise, go to step 502.

Step 514: End.

The process 50 is an example for illustrating a combination of the process 30 and the above examples, and those skilled in the art should readily make modifications or alterations accordingly. Detail of the process 50 can be referred to the above illustration, and are not narrated herein.

Please note that, even though SINRs is used as signal quality in abovementioned embodiments, other signal qualities such as SNRs can also used and is not limited. Besides, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides a method for associating UEs and transmission points by dividing the UEs and the transmission points into groups (i.e., UE groups and transmission groups) such that multi-cell transmissions and receptions are only performed between a UE group and its corresponding transmission group. Therefore, not only throughput of the UE group (i.e., throughputs of the UEs of the UE group) is maximized, but resources (e.g. wireless resources and/or backhaul resources) and latency required for exchanging coordination information between the transmission points is reduced. As a result, benefit of the CoMP (i.e., multi-cell transmissions and receptions) is realized efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of associating a plurality of mobile devices with a plurality of transmission points in a wireless communication system for a set of the plurality of transmission points, the method comprising:
dividing the plurality of mobile devices into a plurality of mobile device groups according to a plurality of signal qualities between the plurality of transmission points and the plurality of mobile devices by using at least one statistical learning technique; and
associating one of the plurality of mobile device groups with one of a plurality of transmission groups, wherein the plurality of transmission groups are obtained from the plurality of transmission points.

2. The method of claim 1, wherein the one of the plurality of transmission groups performs multi-cell transmissions and receptions with the one of the plurality of mobile device groups.

3. The method of claim 2, wherein the multi-cell transmissions and receptions are multi-cell multiple-input multiple-output (MIMO) operations.

4. The method of claim 1, further comprising:
dividing the plurality of transmission points into the plurality of transmission groups according to the plurality of signal qualities between the plurality of transmission points and the plurality of mobile devices by using the at least one statistical learning technique.

5. The method of claim 1, further comprising:
determining the plurality of signal qualities between the plurality of transmission points and the plurality of mobile devices according to a plurality of channel qualities of a plurality of channels between the plurality of transmission points and the plurality of mobile devices.

6. The method of claim 5, wherein the plurality of mobile devices measure the plurality of channel qualities, and feed back the plurality of channel qualities to the set of the plurality of transmission points.

7. The method of claim 6, wherein each of the plurality of mobile devices feed back the plurality of channel qualities by using a channel gain vector or a channel quality indicator (CQI).

8. The method of claim 6, wherein the plurality of mobile devices feed back part of the plurality of channel qualities, if the part of the plurality of channel qualities is above a predetermined level.

9. The method of claim 1, further comprising:
removing a mobile device from the one of the plurality of mobile device groups, if orthogonality between the mobile device and the one of the plurality of mobile device groups is below a predetermined level.

10. The method of claim 1, further comprising:
removing a mobile device from the one of the plurality of mobile device groups, if throughput of the mobile device is larger than a target level.

11. The method of claim 1, wherein a transmission point is a remote radio head, a base station, a relay node or a remote antenna of a base station.

12. The method of claim 11, wherein the set of the plurality of transmission points comprises only at least one serving point.

13. The method of claim 1, wherein the set of the plurality of transmission points are the plurality of transmission points.

14. The method of claim 1, wherein the at least one statistical learning technique comprises at least one of K-Means Clustering and Gaussian Mixtures.

15. The method of claim 1, wherein the plurality of mobile device groups are disjoint.

16. The method of claim 1, wherein the plurality of signal qualities comprises a plurality of signal-to-noise-plus-interference ratios (SINRs) between the plurality of transmission points and the plurality of mobile devices.
